(19) United States
(12) Patent Application Publication
(10) Pub. No.: US 2026/0169710 A1
(43) Pub. Date: Jun. 18, 2026

(54) BI-TREE MODEL FOR COLUMN-LEVEL DATA LINEAGE PARSING OF SQL STATEMENTS

(71) Applicant: eBay Inc., San Jose, CA (US)

(72) Inventors: Duokai Fan, Shanghai (CN); Chunjun Xiao, Shanghai (CN); Yiming Huang, Shanghai (CN); Ying Ma, Shanghai (CN)

(21) Appl. No.: 18/979,524

(22) Filed: Dec. 12, 2024

(51) Int. Cl. G06F 8/41; G06F 16/21

(52) U.S. Cl. CPC G06F 8/427; G06F 16/211

(57) ABSTRACT

A method for extracting column-level data lineage from Structured Query Language (SQL) scripts using a novel Bi-Tree model for efficient and scalable parsing of complex SQL statements is described. In one example embodiment, a computer-implemented method includes parsing a Structured Query Language (SQL) statement to generate an Abstract Syntax Tree (AST), constructing a bi-tree model based on the AST, the bi-tree model includes a context tree and a select-pattern (SP) tree, and extracting column-level lineages based on the bi-tree model.

### TECHNICAL FIELD

The subject matter relates to the field of data lineage parsing and analysis in database systems. More specifically, the present disclosure pertains to methods and systems for extracting column-level data lineage from Structured Query Language (SQL) scripts using a novel Bi-Tree model for efficient and scalable parsing of complex SQL statements.

### BACKGROUND

Data lineage, which includes tracking the origin, transformations, and movement of data over time, has become increasingly crucial in modern data management systems. As organizations deal with complex data workflows, particularly those involving SQL-based operations, the need for accurate and efficient data lineage parsing has grown significantly.

Traditional methods for extracting data lineage, especially at the column level, have faced limitations when dealing with intricate SQL queries involving subqueries, anonymous columns, and implicit mappings. While table-level lineage parsing has been effectively addressed by various tools in the market and open-source community, column-level lineage parsing remains a challenging problem due to the flexible and complex nature of SQL language. Existing approaches, such as runtime parsing through SQL execution engine plugins or simplistic offline parsing methods, often fall short in providing comprehensive, scalable, and non-intrusive solutions for column-level lineage extraction from complex SQL scripts.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 illustrates a process for parsing a SQL statement into a bi-tree model in accordance with one example embodiment.

FIG. 3 is a block diagram illustrating an architecture for parsing a SQL statement, in one example embodiment, in accordance with one example embodiment.

FIG. 4 illustrates an example of constructing a context tree in accordance with one example embodiment.

FIG. 5 illustrates an example of constructing select-pattern nodes in accordance with one example embodiment.

FIG. 6 illustrates an example of constructing select-pattern tress in accordance with one example embodiment.

FIG. 7 illustrates a first round of an AST tree traversal in accordance with one example embodiment.

FIG. 8 illustrates a second round of an AST tree traversal in accordance with one example embodiment.

FIG. 9 illustrates a third round of an AST tree traversal in accordance with one example embodiment.

FIG. 10 is a flow diagram illustrating a method for extracting column-level lineages using a bi-tree model in accordance with one example embodiment.

FIG. 11 is a flow diagram illustrating a method for extracting column-level lineages using a bi-tree model in accordance with another example embodiment.

FIG. 12 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present disclosure introduces a novel approach to parsing column-level data lineage from Structured Query Language (SQL) scripts, addressing the complex challenges associated with extracting detailed lineage information from intricate SQL queries. In one example embodiment, a bi-tree model is disclosed to simplify the process of column-level lineage extraction while offering improved scalability and versatility compared to existing methods. The Bi-Tree model consists of two interconnected tree structures derived from the Abstract Syntax Tree (AST) of a SQL script: the Context Tree and the Select-Pattern Tree (SP Tree).

The Context Tree provides a hierarchical representation of the SQL query structure, with each node corresponding to a SELECT query or subquery within the script. This tree captures the dependencies and context between different parts of the SQL statement, forming the backbone of the lineage parsing process.

Complementing the Context Tree, the Select-Pattern Tree focuses on individual column selections within the SQL script. Each SP Tree node represents a selected column, including those specified by wildcards (e.g., “select *”). The SP Tree nodes are designed to be connected according to the structure defined by the Context Tree, ultimately forming a comprehensive representation of column-level lineage from top-level target columns down to the physical table columns.

In one example, the process operates through a three-round parsing process based on the bi-tree model to efficiently extract column-level lineage information:

In the first round, the method constructs the Context Tree and creates initial SP Tree nodes while resolving named columns. This step establishes the foundational structure for subsequent lineage analysis.

The second round focuses on resolving unnamed columns, particularly those resulting from “select *” statements. This involves uplifting dependent nodes and splitting wildcard nodes into individual named column nodes, ensuring comprehensive coverage of all relevant columns.

The final round connects the SP Tree nodes according to the Context Tree, linking from top root nodes to bottom leaf nodes. This step completes the lineage mapping, allowing for the extraction of detailed column-level lineage information.

By operating independently of SQL execution engines, the presently described process provides a lightweight, flexible, and extensible solution that can be easily adapted to support various SQL dialects. This approach allows for selective parsing of SQL scripts and scheduled lineage extraction, offering greater control and efficiency in managing data lineage processes.

The Bi-Tree model and associated parsing method demonstrate superior capabilities in handling complex SQL structures, including scenarios involving subqueries, anonymous columns, aliases, and implicit column mappings. As such, the presently described process addresses the challenges posed by modern data workflows, where SQL scripts can span thousands of lines and incorporate numerous query sub-clauses, Common Table Expressions (CTEs), and embedded subqueries. Furthermore, the process's design facilitates seamless integration with existing systems and tools, such as Spark SQL Parser and Hive Metastore, enhancing its practical applicability in diverse data management environments. The integration capability, combined with the invention's inherent scalability and versatility, positions it as a significant advancement in the field of data lineage analysis and management.

In one example embodiment, a method for extracting column-level data lineage from Structured Query Language (SQL) scripts using a novel Bi-Tree model for efficient and scalable parsing of complex SQL statements is described. A computer-implemented method includes parsing a Structured Query Language (SQL) statement to generate an Abstract Syntax Tree (AST), constructing a bi-tree model based on the AST, the bi-tree model includes a context tree and a select-pattern (SP) tree, and extracting column-level lineages based on the bi-tree model.

As a result, one or more of the methodologies described herein facilitate solving the technical problem of efficiently extracting column-level data lineage from Structured Query Language (SQL) scripts. As such, one or more of the methodologies described herein may obviate a need for certain efforts or computing resources that otherwise would be involved in failing to access data from a local compressed cache. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

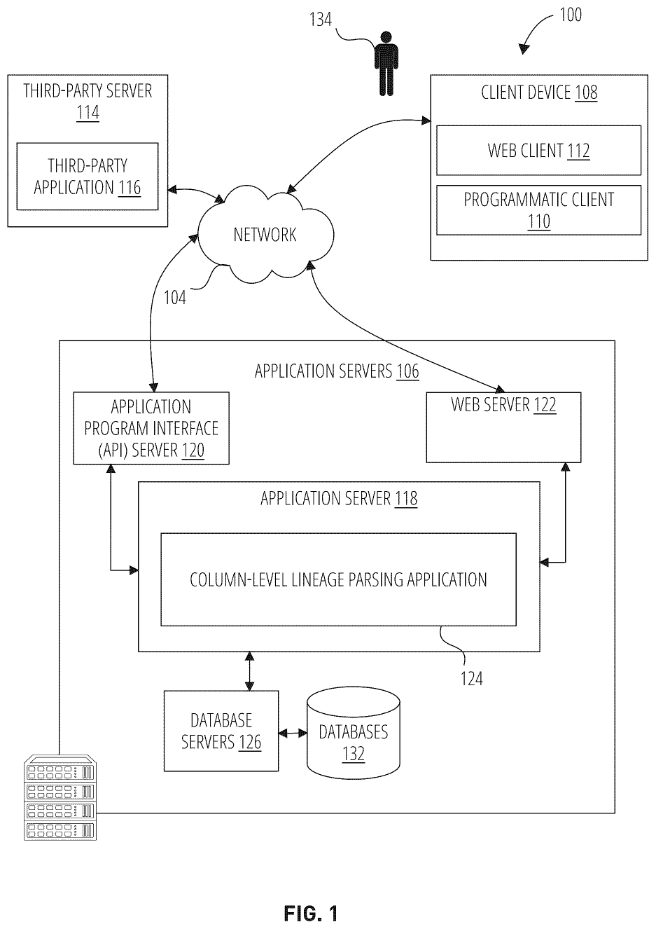

FIG. 1 is a diagrammatic representation of a network environment 100 in which some example embodiments of the present disclosure may be implemented or deployed. One or more application servers 106 provide server-side functionality via a network 104 to a networked user device, in the form of a client device 110. A web client 112 (e.g., a browser) and a programmatic client 110 (e.g., an “app”) are hosted and execute on the web client 112.

An Application Program Interface (API) server 120 and a web server 122 provide respective programmatic and web interfaces to application servers 106. A specific application server 118 hosts a column-level lineage parsing application 124, which includes components, modules and/or applications.

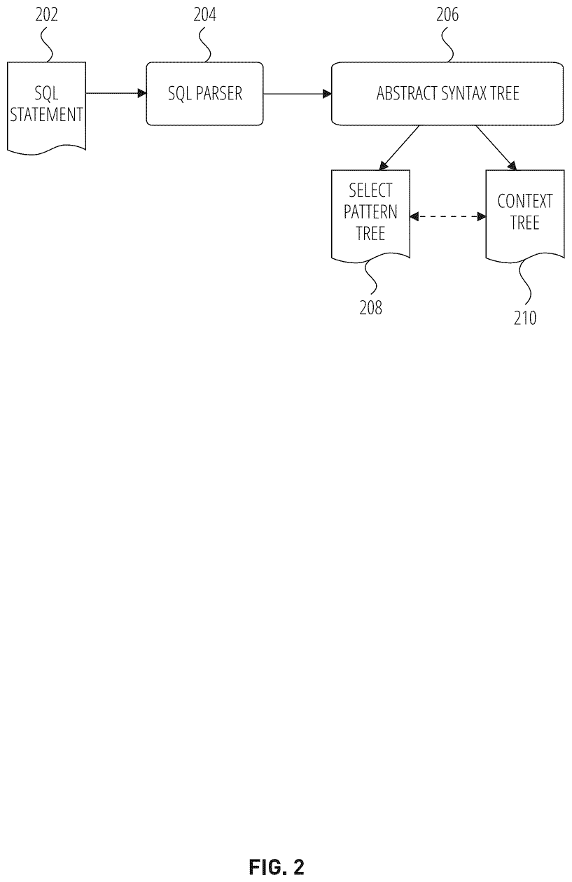

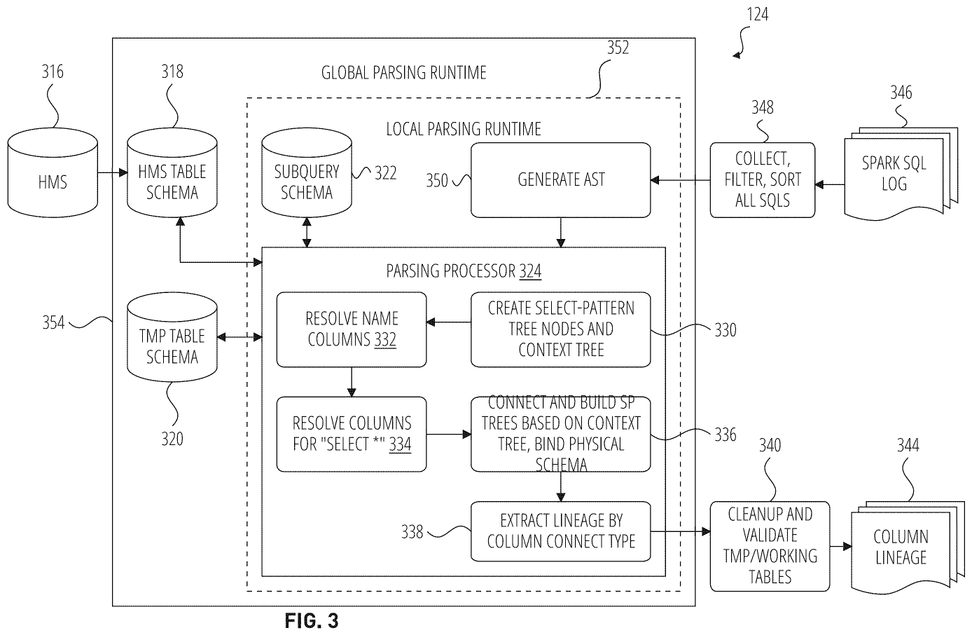

The column-level lineage parsing application 124 may provide a number of functions and services to users who access the application servers 106. For example, the column-level lineage parsing application 124 processes parsing column-level data lineage from Structured Query Language (SQL) scripts. While the column-level lineage parsing application 124 is shown in FIG. 1 to be part of the application servers 106, it will be appreciated that, in alternative embodiments, the column-level lineage parsing application 124 may be separate and distinct from the application server 118. The column-level lineage parsing application 124 is described in more detail below with respect to FIG. 2 and FIG. 3.

Further, while the network environment 100 shown in FIG. 1 employs a client-server architecture, the embodiments are, of course, not limited to such an architecture, and could equally well find application in a distributed, or peer-to-peer, architecture system, for example. The column-level lineage parsing application 124 could also be implemented as a standalone software program, which do not necessarily have networking capabilities.

The web client 112 accesses the column-level lineage parsing application 124 via the web interface supported by the web server 122. Similarly, the programmatic client 110 accesses the various services and functions provided by the column-level lineage parsing application 124 via the programmatic interface provided by the Application Program Interface (API) server 120. In one example, the programmatic client 110 includes a client-based graph query application.

FIG. 1 also illustrates a third-party application 116 executing on a third-party server 114 as having programmatic access to the application servers 106 via the programmatic interface provided by the Application Program Interface (API) server 120. For example, the third-party application 116 may, utilizing information retrieved from the application server 118, support one or more features or functions on a website hosted by a third party.

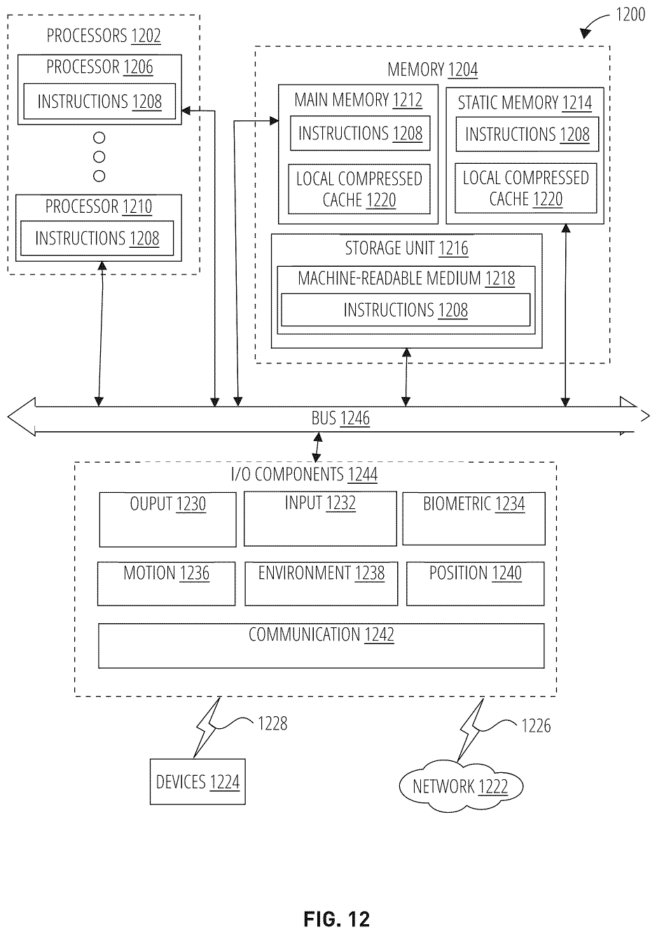

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other programs) to perform one or more of the functions described herein for that system or machine. For example, a special-purpose computer system able to implement any one or more of the methodologies described herein is discussed below with respect to FIG. 12, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and type of client device 108 may be embodied within the network environment 100. Furthermore, some components or functions of the network environment 100 may be combined or located elsewhere in the network environment 100. For example, some of the functions of the client device 108 may be embodied at the application server 118.

FIG. 2 illustrates a process for parsing a SQL statement into a bi-tree model in accordance with one example embodiment. The SQL statement 202 represents the input SQL query that needs to be parsed for column-level lineage. The SQL statement 202 is fed into a SQL parser 204 that processes the raw SQL and generates an abstract syntax tree 206. The abstract syntax tree 206 represents the hierarchical structure of the SQL statement 202 in a tree format. The abstract syntax tree 206 serves as the foundation for constructing the Bi-Tree model that is composed of a select pattern tree 208 and a context tree 210.

The context tree 210 represents the structure of the SQL query, with nodes corresponding to SELECT queries or subqueries within the SQL statement 202. The context tree 210 captures the dependencies and context between different parts of the query.

The select pattern tree 208 focuses on individual column selections within the SQL statement 202. Each node in this tree represents a selected column, including those specified by wildcards (e.g., “select *”). The above process is described in more detail below with respect to FIG. 3.

FIG. 3 is a block diagram illustrating an architecture for a column-level lineage parsing application 124, in one example embodiment, in accordance with one example embodiment. The column-level lineage parsing application 124 includes a global parsing runtime 354 and a local parsing runtime 352.

The global parsing runtime 354 manages multiple SQL statements. In one example, the global parsing runtime 354 accesses SQL statements from collect, filter, sort all SQLs 348, which gathers and organizes the SQL statements to be processed. The collect, filter, sort all SQLs 348 step takes input from the spark SQL log 346.

The local parsing runtime 352 focuses on processing individual SQL statements. In one example, the local parsing runtime 352 consists of generate AST 350, and parsing processor 324.

The generate AST 350 module generates an Abstract Syntax Tree (AST) using the Spark SQL Parser. This step transforms the raw SQL into a structured representation that can be easily analyzed.

Column-level lineage parsing application 124 interacts with HMS 316 to obtain schema information for tables referenced in the SQL statements. This includes HMS table schema 318 that provides the schema for known tables. The subquery schema 322 handles schemas for subqueries, which may create temporary or anonymous tables. The tmp table schema 320 manages schemas for temporary tables created during the parsing process.

The process of the parsing processor 324 comprises the following operations: create select-pattern tree nodes and context tree 330, resolve name columns 332, resolve columns for “select *” 334, connect and build SP trees based on context tree, bind physical schema 336, extract lineage by column connect type 338.

The operation create select-pattern tree nodes and context tree 330 implements the Bi-Tree model, to create both the Context Tree and the initial SP Tree nodes.

The operation resolve name columns 332 identifies and resolves explicitly named columns in the SQL statement. The operation resolve columns for “select *” 334 handles wildcard selections, expanding them into individual column references. The operation connect and build SP trees based on context tree, bind physical schema 336 links the SP Tree nodes according to the context tree structure, and associates them with the actual database schema. The operations extract lineage by column connect type 338 extracts the column-level lineage based on the connections established in the previous steps.

The operation cleanup and validate tmp/working tables 340 ensures that any temporary data structures created during the parsing process are properly managed and validated. The output of the entire process is the column lineage 344, represented as graph edges, which provides a detailed mapping of how columns are related and transformed through the SQL operations.

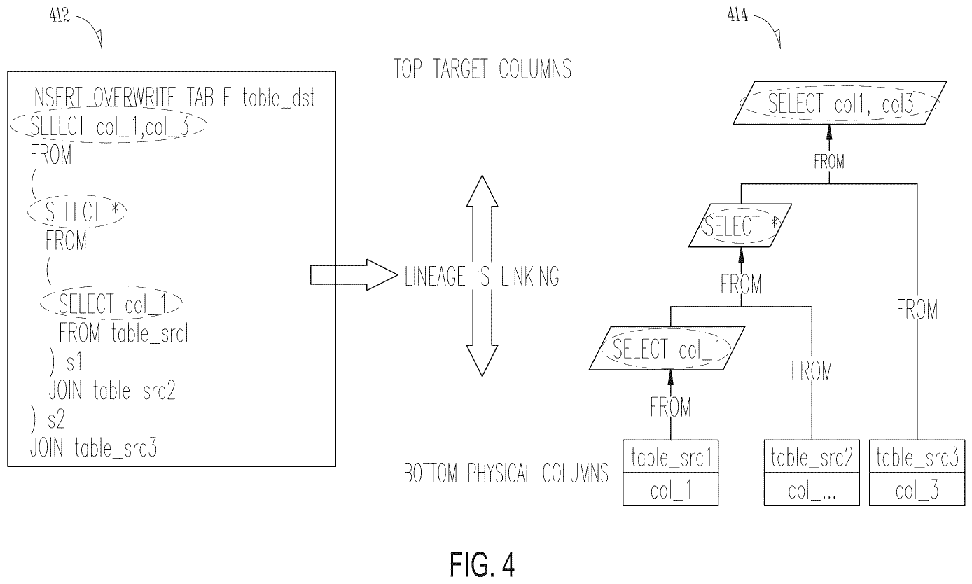

FIG. 4 illustrates an example of constructing a context tree in accordance with one example embodiment. In particular, FIG. 4 illustrates the concept of column-level lineage parsing using the Bi-Tree model, specifically demonstrating how the invention links top target columns to bottom physical columns through a complex SQL query structure.

FIG. 4 illustrates two sections: a SQL statement 412 and a context tree 414. The SQL statement 412 shows a sample SQL query with nested subqueries and joins. The query includes:
An INSERT OVERWRITE statement targeting a destination table (table_dst)
Multiple nested SELECT statements
JOIN operations between different tables (table_src1, table_src2, table_src3)
Column selections, including specific columns (col_1, col_3) and wildcard selections (*)

The context tree 414 illustrates a column lineage visualization, and how the Bi-Tree model represents and traces the column-level lineage through the complex query structure.

The Top Target Columns, represented at the top of the lineage structure, show the final selected columns (col1, col3) that will be inserted into the destination table. The context tree 414 shows how the lineage is traced through multiple levels of subqueries and joins. Each level corresponds to a SELECT statement in the SQL query. At the bottom of the lineage structure, FIG. 4 shows the original source columns from the physical tables (table_src1, table_src2, table_src3). The arrowed lines connect the columns across different levels, visually representing the lineage relationships. These connections illustrate how the operation traces column lineage from the top target columns down to the bottom physical columns through various transformations and selections in the SQL query.

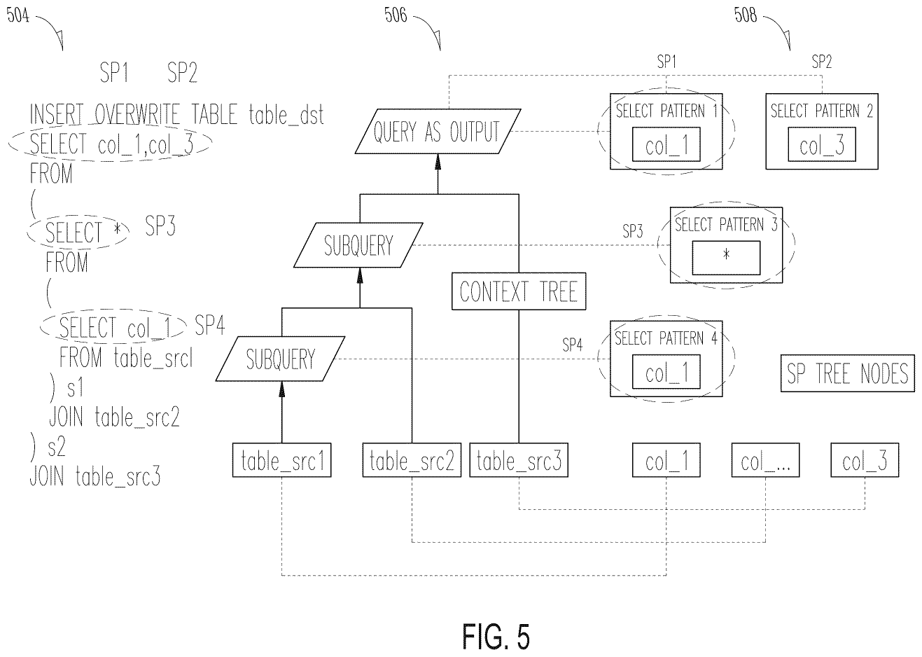

FIG. 5 illustrates an example of constructing select-pattern nodes in accordance with one example embodiment. FIG. 5 illustrates the first round of the three-round parsing process used in the Bi-Tree model for column-level data lineage extraction from SQL scripts. FIG. 5 shows how the Context Tree and Select-Pattern (SP) Tree nodes are initially created and populated based on the input SQL query.

FIG. 5 is divided into three main sections: SQL statement 504, context tree 506, and select tree nodes 508.

The SQL statement 504 illustrates a sample SQL query with nested subqueries and joins. This SQL query serves as the input for the parsing process.

The context tree 506 represents the hierarchical structure of the SQL statement 504, with each node corresponding to a SELECT statement or subquery within the SQL statement 504. The Context Tree nodes are labeled and connected to reflect the nesting and relationships between different parts of the query. Each SELECT statement becomes a node in the context tree 506.

The select tree nodes 508 represent the columns selected in various parts of the SQL query. In this first round of parsing, the SP Tree nodes are created but not yet fully connected. For each SELECT statement in the SQL query, the corresponding selected columns are identified and represented as SP Tree nodes. This includes handling specific column selections (e.g., col_1, col_3) as well as wildcard selections (SELECT *).

While the SP Tree nodes are not fully connected in this round, their creation and association with Context Tree nodes set the stage for the subsequent rounds of parsing, where unnamed columns will be resolved and the full lineage connections will be established.

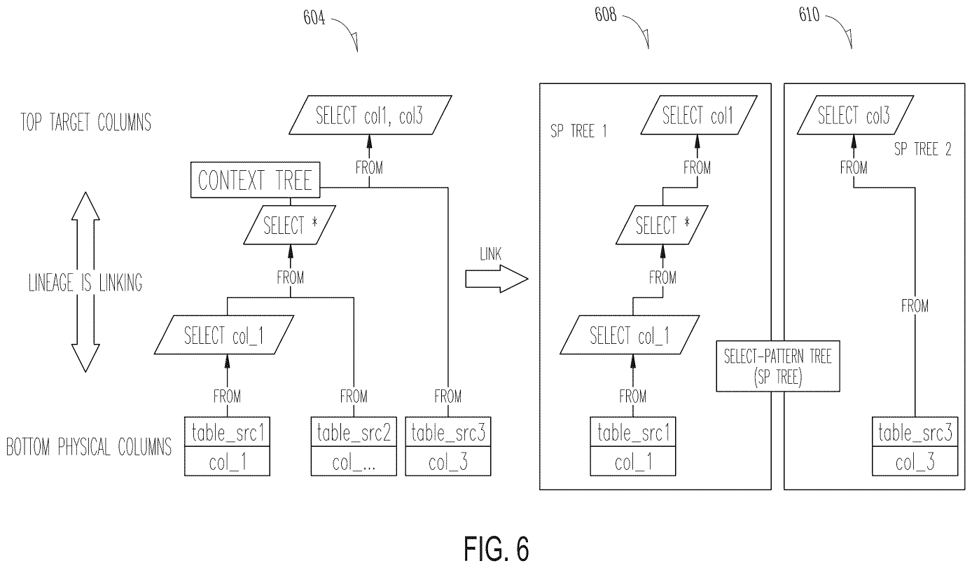

FIG. 6 illustrates an example of constructing select-pattern trees in accordance with one example embodiment. FIG. 6 illustrates the final round of the three-round parsing process in the Bi-Tree model for column-level data lineage extraction from SQL scripts. FIG. 6 focuses on resolving unnamed columns, particularly those resulting from wildcard selections (SELECT *), and further developing the Select-Pattern (SP) Tree structure.

FIG. 6 is divided into three main sections: context tree 604, select pattern tree 608, and select pattern tree 610. The context tree 604 remains unchanged from the first round, maintaining the hierarchical structure of the SQL query.

The select pattern tree 608 and select pattern tree 610 show the evolution of the SP Trees, demonstrating how unnamed columns are resolved and the trees are further developed. For example, the final parsing process includes the resolution of wildcard selections, creation of multiple SP trees, and uplifting of dependent nodes, partial connection of SP tree nodes, handling of joins and subqueries, preparation for the final round, linkage to physical columns.

In the resolution of wildcard selections, FIG. 6 shows how “select *” statements are expanded into individual column references. For example, the wildcard selection in the middle-level query is resolved into specific columns (col_1, col_ . . . ).

In the creation of multiple SP trees, unlike in the first round, FIG. 6 shows the formation of multiple SP Trees, each corresponding to a top-level target column. Two distinct SP Trees are visible, one for “col1” and another for “col3”.

In the uplifting of dependent nodes, FIG. 6 shows how columns selected in subqueries are “uplifted” to higher levels in the SP Trees, establishing clearer lineage paths.

In the partial connection of SP tree nodes, while not fully connected, the SP Tree nodes now show more structure, with arrows indicating the flow of data from lower-level selections to higher-level ones.

In the handling of joins and subqueries. FIG. 6 illustrates how the parsing process deals with joined tables and subqueries by incorporating their columns into the appropriate SP trees.

In preparation for final round, partially connected SP trees set the stage for the third round of parsing, where full lineage connections will be established.

In linkage to physical columns, at the bottom of the SP trees, FIG. 6 shows the connection to the physical columns in the source tables (table_src1, table_src2, table_src3), demonstrating how the lineage is traced back to the original data sources.

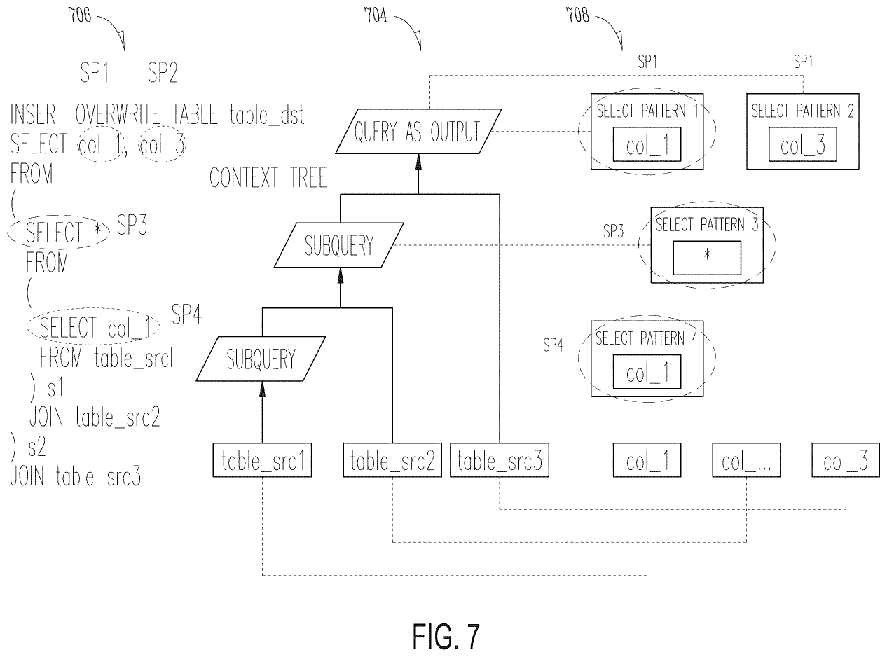

FIG. 7 illustrates the first round of an AST tree traversal process in the bi-tree model for column-level data lineage extraction from SQL scripts. FIG. 7 shows SQL statement 706, context tree 704, and SP tree nodes 708. FIG. 7 shows an example of the initial creation of the context tree 704 and SP tree nodes 708 based on the input SQL query (e.g., SQL statement 706).

The SQL statement 706 represents the input for the parsing process. This query includes nested subqueries, joins, and various column selections.

The context tree 704 represents the hierarchical structure of the SQL query, with each node corresponding to a SELECT statement or subquery within the SQL script. The nodes of the context tree 704 are labeled (e.g., “Query as Output”, “Subquery”) and connected to reflect the nesting and relationships between different parts of the SQL query.

The SP tree nodes 708 represent the columns selected in various parts of the SQL query. In this first round of parsing, the SP tree nodes 708 (e.g., SP1, SP2, SP3, SP4) are created but not yet fully connected. For each SELECT statement in SQL statement 706, the corresponding selected columns are identified and represented as SP tree nodes 708. This includes handling specific column selections (e.g., col_1, col_3) as well as wildcard selections (SELECT *).

While the SP tree nodes 708 are not fully connected in this round, their creation and association with nodes from context tree 704 set the stage for the subsequent rounds of parsing, where unnamed columns will be resolved and the full lineage connections will be established. The bottom of FIG. 7 shows the physical source tables (table_src1, table_src2, table_src3), indicating the origin of the columns in the query.

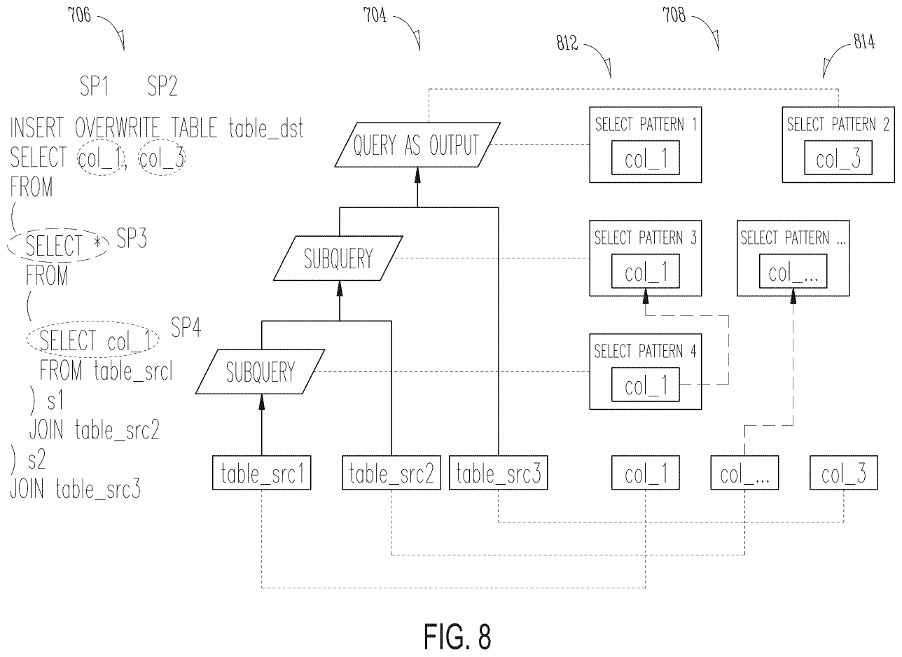

FIG. 8 illustrates a second round of the three-round parsing process in the Bi-Tree model for column-level data lineage extraction from SQL scripts. FIG. 8 focuses on resolving unnamed columns, particularly those resulting from wildcard selections (SELECT *), and further developing the Select-Pattern (SP) Tree structure.

The SP tree nodes 708 show the evolution of the SP trees, and how unnamed columns are resolved and the trees are further developed. For example, SP tree nodes 708 shows how “SELECT *” statements are expanded into individual column references. For example, the wildcard selection in the middle-level query is resolved into specific columns (col_1, col_4, col_ . . . ). Unlike in the first round, FIG. 8 shows the formation of multiple SP Trees, each corresponding to a top-level target column. Two distinct SP Trees (e.g., SP tree 812 and SP tree 814) are visible, one for “col_1” and another for “col_3”. FIG. 8 illustrates how columns selected in subqueries are “uplifted” to higher levels in the SP Trees, establishing clearer lineage paths. While not fully connected, the SP tree nodes 708 now show more structure, with arrows indicating the flow of data from lower-level selections to higher-level ones. As such, FIG. 8 illustrates how the parsing process deals with joined tables and subqueries by incorporating their columns into the appropriate SP Trees (e.g., SP tree 812, SP tree 814).

The partially connected SP trees set the stage for the third round of parsing, where full lineage connections will be established. At the bottom of the SP Trees, FIG. 8 shows the connection to the physical columns in the source tables (table_src1, table_src2, table_src3), demonstrating how the lineage is traced back to the original data sources.

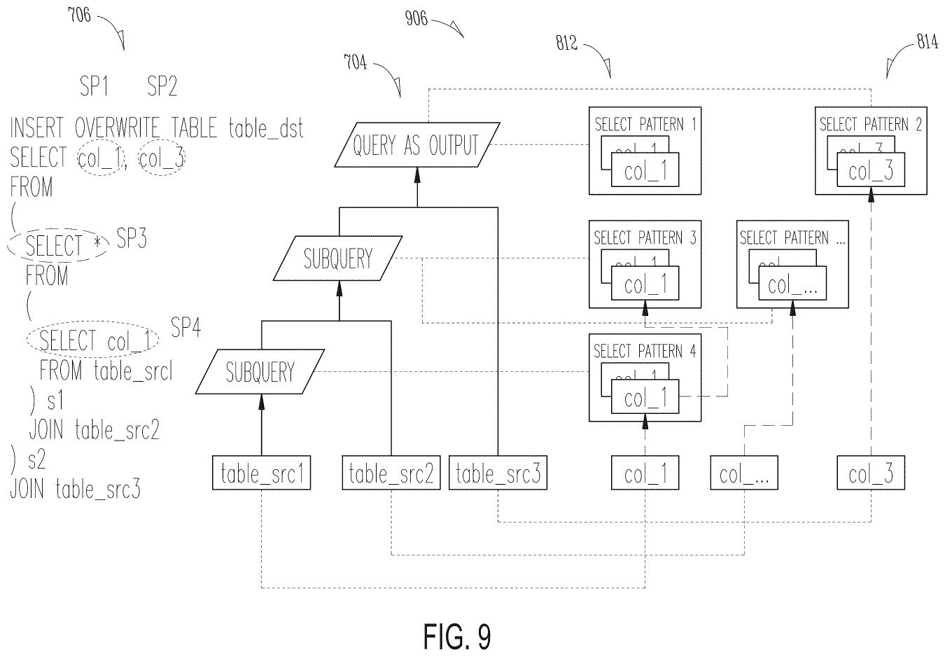

FIG. 9 illustrates the third and final round of the three-round parsing process in the Bi-Tree model for column-level data lineage extraction from SQL scripts.

This figure demonstrates the complete connection of the SP trees 906 and the extraction of the full column-level lineage. The SP trees 906 are now fully connected, with arrows showing the flow of data from source columns to target columns through various transformations in the SQL query. For example, SP trees 906 shows SP tree 812 and SP tree 814, one for each top-level target column (col_1 and col_3). All columns, including those previously represented by wildcards, are now resolved to specific column names (e.g., col_1, col_3, col_4). The SP trees 906 allows for tracing lineage through multiple levels of query nesting, showing the complete path from source columns to target columns. For example, FIG. 9 illustrates how each target column (col_1 and col_3) is derived from specific source columns in the original tables (table_src1, table_src2, table_src3).

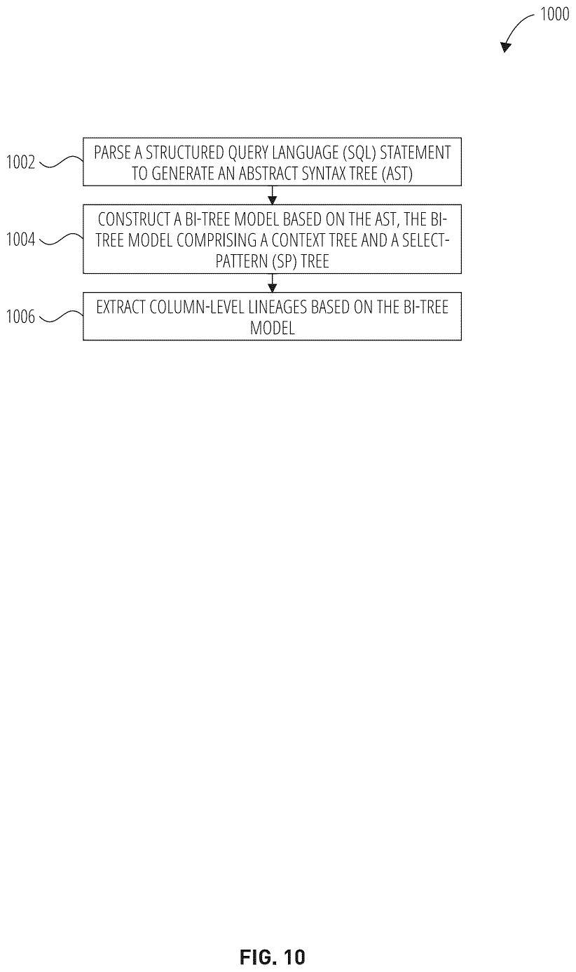

FIG. 10 is a flow diagram illustrating a routine 1000 for extracting column-level lineages using a bi-tree model in accordance with one example embodiment. Although the example routine 1000 depicts a particular sequence of operations, the sequence may be altered without departing from the scope of the present disclosure. For example, some of the operations depicted may be performed in parallel or in a different sequence that does not materially affect the function of the routine 1000. In other examples, different components of an example device or system that implements the routine 1000 may perform functions at substantially the same time or in a specific sequence.

According to some examples, the method includes parsing a structured query language (SQL) statement to generate an abstract syntax tree (AST) at block 1002. This initial step involves taking the input SQL statement and transforming it into an Abstract Syntax Tree representation.

In one example embodiment, the parsing of SQL statements and generation of the Abstract Syntax Tree (AST) can be performed using a SQL parser (e.g., Spark SQL Parser).

The following is an example of a process of parsing and generating the AST:
Lexical Analysis: The SQL statement is first broken down into a series of tokens using a lexical analyzer (lexer). This process involves identifying keywords, operators, identifiers, and literals in the SQL text. Common algorithms for lexical analysis include:
   Finite State Automata (FSA)
   Regular Expressions
Syntactic Analysis: The tokens are then analyzed for their grammatical structure using a parser. This step constructs the AST based on the SQL grammar. Common parsing algorithms include:
   Recursive Descent Parsing
   LALR (Look-Ahead LR) Parsing
   LL(k) Parsing
AST Construction: As the parser recognizes valid SQL constructs, it builds the AST. Each node in the AST typically represents a construct in the SQL statement (e.g., SELECT, FROM, WHERE clauses, column references, table references, etc.).

For the Spark SQL Parser, a combination of these techniques can be used. Spark SQL is built on top of Apache Spark and uses the Catalyst optimizer, which includes a SQL parser. The Catalyst framework uses a tree-based architecture for query representation and optimization.

The following is an example of how the AST might be generated for a simple SQL query:
SELECT col1, col2 FROM table 1 WHERE col3>10

In the context of the Bi-Tree model, the AST serves as the foundation for constructing both the Context Tree and the Select-Pattern Tree. The parsing process extracts relevant information from the AST to populate these trees:
For the Context Tree:
   Identify SELECT statements and subqueries
   Determine the hierarchical relationships between queries
For the Select-Pattern Tree:
   Identify column selections, including wildcard selections
   Extract information about table references and join conditions

Examples of algorithms used for traversing the AST and constructing the Bi-Tree model include depth-first or breadth-first traversal of the AST to extract the necessary information for building the Context Tree and initial Select-Pattern Tree nodes.

The Spark SQL Parser is used as part of a larger system that includes interaction with the Hive Metastore for schema information, which is used for resolving wildcard selections and binding columns to their physical schemas in subsequent parsing rounds.

According to some examples, the method includes constructing a bi-tree model based on the AST, the bi-tree model comprising a context tree, and a select-pattern (SP) tree at block 1004. The Bi-Tree model consists of two interconnected tree structures: (1) context tree, which represents the hierarchical structure of the SQL query, with nodes corresponding to SELECT statements and subqueries. (2) Select-Pattern (SP) tree, which focuses on individual column selections within the SQL script.

For the context tree construction: The Context Tree is built based on the structure of the SQL query, representing the hierarchical relationships between different parts of the query.
1. Each node in the Context Tree corresponds to a SELECT statement or subquery within the SQL script. The process involves:
a. Identifying each SELECT statement and subquery in the AST. b. Creating a node for each identified statement. c. Establishing parent-child relationships between nodes based on the nesting structure of the query. d. Labeling nodes to reflect their role in the query (e.g., “Query as Output”, “Subquery”).

For the Select-Pattern (SP) Tree Node Creation: The initial SP Tree nodes are created in parallel with the Context Tree construction. This process involves:
a. Identifying column selections in each SELECT statement, including specific columns and wildcard selections (SELECT *). b. Creating an SP Tree node for each identified column selection. c. Associating each SP Tree node with its corresponding Context Tree node.

For resolving unnamed columns: In the second round of parsing, the SP Tree is further developed by resolving unnamed columns, particularly those resulting from wildcard selections:
a. Expanding “SELECT *” statements into individual column references. b. Uplifting columns selected in subqueries to higher levels in the SP Trees. c. Creating multiple SP Trees, each corresponding to a top-level target column.

For connecting SP Tree Nodes: In the final round of parsing, the SP Tree nodes are fully connected to represent the complete column-level lineage:
a. Establishing connections between SP Tree nodes based on the relationships defined in the Context Tree. b. Tracing the lineage of each column from the top-level target columns down to the source columns in the physical tables. c. Handling transformations, joins, and other SQL operations that affect column lineage.

For the integration with Metadata: Throughout the construction process, the Bi-Tree model interacts with the Hive Metastore to obtain schema information for tables referenced in the SQL statements. This integration helps in:
a. Resolving table and column names. b. Handling schemas for subqueries and temporary tables. c. Binding columns to their physical schemas.

The Bi-Tree model construction process is designed to handle complex SQL structures, including nested queries, joins, and various column transformations. By separating the query context (Context Tree) from the column selections and lineage (SP Trees), the model provides a flexible and comprehensive representation of column-level data lineage.

According to some examples, the method includes extracting column-level lineages based on the bi-tree model at block 1006. This step involves using the constructed Bi-Tree model to trace and extract the column-level lineage information. This process maps the relationships between source columns and target columns through the various transformations and operations defined in the SQL query.

In one example, the extraction of column-level lineages is performed in the third and final round of the parsing process using the fully constructed Bi-Tree model. The following is an example operation of how the column-level lineages are extracted:
Complete SP Tree Connection: The Select-Pattern (SP) Trees are fully connected, with arrows clearly showing the flow of data from source columns to target columns through various transformations in the SQL query.
Multi-level Lineage Tracing: The SP Trees demonstrate the ability to trace lineage through multiple levels of query nesting, showing the complete path from source columns to target columns.
Source to Target Mapping: The process clearly illustrates how each target column (e.g., col_1 and col_3) is derived from specific source columns in the original tables (table_src1, table_src2, table_src3).
Handling of Transformations: The structure of the SP Trees allows for handling column transformations and aliases that may occur in complex SQL queries.
Subquery and Join Resolution: Columns from subqueries and joined tables are fully integrated into the lineage, with clear paths tracing back to their origins.
Final Lineage Extraction: The fully connected SP Trees represent the extracted column-level lineage, which can be used for various data management and analysis purposes.
Linkage to Physical Columns: The process establishes connections to the physical columns in the source tables, demonstrating how the lineage is traced back to the original data sources.

The extraction process leverages the Context Tree to navigate the hierarchical structure of the SQL query while using the SP Trees to map the specific column-level relationships. This approach allows for comprehensive lineage tracing in complex SQL queries, handling nested structures, joins, and multiple transformations.

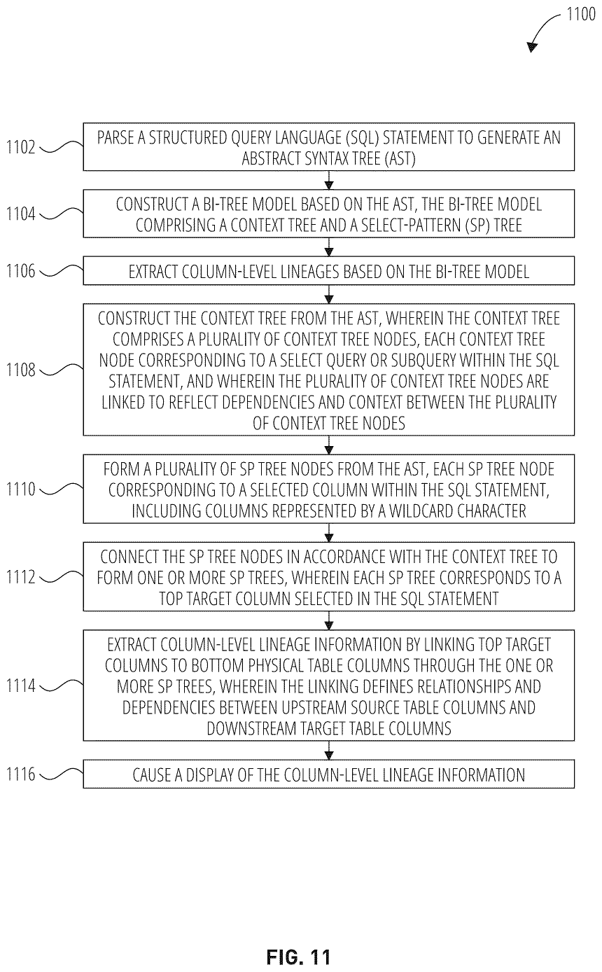

FIG. 11 is a flow diagram illustrating a routine 1100 for extracting column-level lineages using a bi-tree model in accordance with another example embodiment. Although the example routine 1100 depicts a particular sequence of operations, the sequence may be altered without departing from the scope of the present disclosure. For example, some of the operations depicted may be performed in parallel or in a different sequence that does not materially affect the function of the routine 1100. In other examples, different components of an example device or system that implements the routine 1100 may perform functions at substantially the same time or in a specific sequence.

According to some examples, the method includes parsing a structured query language (SQL) statement to generate an abstract syntax tree (AST) at block 1102. This step involves using a SQL parser, such as the Spark SQL Parser, to transform the input SQL statement into an AST.

For example, for a SQL query like: SELECT col1, col3 FROM (SELECT * FROM table_src1) s1 JOIN table_src2, the parser generates an AST representing the structure of this query, including the SELECT, FROM, and JOIN clauses, as well as the subquery.

According to some examples, the method includes constructing a bi-tree model based on the AST, the bi-tree model comprising a context tree, and a select-pattern (SP) tree at block 1104. This step involves creating two interconnected tree structures:
a. Context Tree:
   Identify each SELECT statement and subquery in the AST.
   Create nodes for each statement, establishing parent-child relationships.
b. SP Tree:
   Create nodes for each column selection (col1, col3, *).
   Associate these nodes with corresponding Context Tree nodes.

According to some examples, the method includes extracting column-level lineages based on the bi-tree model at block 1106. This step involves using the fully constructed Bi-Tree model to trace and extract the column-level lineage information. Block 1106 maps the relationships between source columns and target columns through various transformations and operations defined in the SQL query. Block 1106 leverages both the Context Tree and the Select-Pattern (SP) Trees to navigate the hierarchical structure of the SQL query and map specific column-level relationships.

According to some examples, the method includes constructing the context tree from the AST, wherein the context tree comprises a plurality of context tree nodes, each context tree node corresponding to a SELECT query or subquery within the SQL statement, and wherein the plurality of context tree nodes are linked to reflect dependencies and context between the plurality of context tree nodes at block 1108. In one example, the Context Tree is built by analyzing the Abstract Syntax Tree (AST) of the SQL query. Each node in the Context Tree corresponds to a SELECT query or subquery within the SQL statement. These nodes are linked to reflect the dependencies and context between different parts of the query. For example, in a query with nested subqueries, the Context Tree would have a hierarchical structure mirroring the nesting of these subqueries.

According to some examples, the method includes forming a plurality of SP tree nodes from the AST, each SP tree node corresponding to a selected column within the SQL statement, including columns represented by a wildcard character at block 1110. In one example, this step involves creating Select-Pattern (SP) Tree nodes for each selected column within the SQL statement. This includes handling specific column selections as well as columns represented by wildcard characters (SELECT *). For instance, in a query like “SELECT col1, col2, * FROM table1”, SP Tree nodes would be created for ‘col1’, ‘col2’, and a node representing the wildcard selection.

According to some examples, the method includes connecting the SP tree nodes in accordance with the context tree to form one or more SP trees, wherein each SP tree corresponds to a top target column selected in the SQL statement at block 1112. In one example, the SP Tree nodes are connected based on the structure provided by the Context Tree. This process forms one or more SP Trees, where each SP Tree corresponds to a top target column selected in the SQL statement. The connections between SP Tree nodes reflect how data flows through the query, including through subqueries and joins.

According to some examples, the method includes extracting column-level lineage information by linking top target columns to bottom physical table columns through one or more SP trees, wherein the linking defines relationships and dependencies between upstream source table columns and downstream target table columns at block 1114. For example, if a query joins two tables and selects a column from each, the lineage would show how these source columns flow through the query operations to become the final output columns.

According to some examples, the method includes causing a display of the column-level lineage information at block 1116.

In block 1102, routine 1100 parses a Structured Query Language (SQL) statement to generate an Abstract Syntax Tree (AST). In block 1104, routine 1100 constructs a bi-tree model based on the AST, the bi-tree model comprising a context tree and a select-pattern (SP) tree. In block 1106, routine 1100 extracts column-level lineages based on the bi-tree model. In block 1108, routine 1100 constructs the context tree from the AST, wherein the context tree comprises a plurality of context tree nodes, each context tree node corresponding to a SELECT query or subquery within the SQL statement, and wherein the plurality of context tree nodes are linked to reflect dependencies and context between the plurality of context tree nodes. In block 1110, routine 1100 forms a plurality of SP tree nodes from the AST, each SP tree node corresponding to a selected column within the SQL statement, including columns represented by a wildcard character. In block 1112, routine 1100 connects the SP tree nodes in accordance with the context tree to form one or more SP trees, wherein each SP tree corresponds to a top target column selected in the SQL statement. In block 1114, routine 1100 extracts column-level lineage information by linking top target columns to bottom physical table columns through one or more SP trees, wherein the linking defines relationships and dependencies between upstream source table columns and downstream target table columns. In block 1116, routine 1100 causes a display of the column-level lineage information.

FIG. 12 is a diagrammatic representation of the machine 1200 within which instructions 1208 (e.g., software, a program, an application, an applet, an app, or other executable code) for causing the machine 1200 to perform any one or more of the methodologies discussed herein may be executed. For example, the instructions 1208 may cause the machine 1200 to execute any one or more of the methods described herein. The instructions 1208 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while only a single machine 1200 is illustrated, the term “machine” shall also be taken to include a collection of machines that individually or jointly execute the instructions 1208 to perform any one or more of the methodologies discussed herein.

The machine 1200 may include processors 1202, memory 1204, and I/O components 1244, which may be configured to communicate with each other via a bus 1246. In an example embodiment, the processors 1202 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1206 and a processor 1210 that execute the instructions 1208. The term “processor” is intended to include multi-core processors that may comprise two or more independent processors (sometimes referred to as “cores”) that may execute instructions contemporaneously. Although FIG. 12 shows multiple processors 1202, the machine 1200 may include a single processor with a single core, a single processor with multiple cores (e.g., a multi-core processor), multiple processors with a single core, multiple processors with multiples cores, or any combination thereof.

The memory 1204 includes a main memory 1212, a static memory 1214, and a storage unit 1216, both accessible to the processors 1202 via the bus 1246. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the processors 1202 (e.g., within the processor's cache memory), or any suitable combination thereof, during execution thereof by the machine 1200.

The I/O components 1244 may include a wide variety of components to receive input, provide output, produce output, transmit information, exchange information, capture measurements, and so on. The specific I/O components 1244 that are included in a particular machine will depend on the type of machine. For example, portable machines such as mobile phones may include a touch input device or other such input mechanisms, while a headless server machine will likely not include such a touch input device. It will be appreciated that the I/O components 1244 may include many other components that are not shown in FIG. 12. In various example embodiments, the I/O components 1244 may include output components 1230 and input components 1232. The output components 1230 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1232 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1244 may include biometric components 1234, motion components 1236, environmental components 1238, or position components 1240, among a wide array of other components. For example, the biometric components 1234 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1236 include acceleration sensor components (e.g., accelerometer), gravitation sensor components, rotation sensor components (e.g., gyroscope), and so forth. The environmental components 1238 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1240 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1244 further include communication components 1242 operable to couple the machine 1200 to a network 1222 or devices 1224 via a coupling 1226 and a coupling 1228, respectively. For example, the communication components 1242 may include a network interface component or another suitable device to interface with the network 1222. In further examples, the communication components 1242 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1224 may be another machine or any of a wide variety of peripheral devices (e.g., a peripheral device coupled via a USB).

Moreover, the communication components 1242 may detect identifiers or include components operable to detect identifiers. For example, the communication components 1242 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1242, such as location via Internet Protocol (IP) geolocation, location via Wi-Fi® signal triangulation, location via detecting an NFC beacon signal that may indicate a particular location, and so forth.

The various memories (e.g., memory 1204, main memory 1212, static memory 1214, and/or memory of the processors 1202) and/or storage unit 1216 may store one or more sets of instructions and data structures (e.g., software) embodying or used by any one or more of the methodologies or functions described herein. These instructions (e.g., the instructions 1208), when executed by processors 1202, cause various operations to implement the disclosed embodiments.

The instructions 1208 may be transmitted or received over the network 1222, using a transmission medium, via a network interface device (e.g., a network interface component included in the communication components 1242) and using any one of a number of well-known transfer protocols (e.g., hypertext transfer protocol (HTTP)). Similarly, the instructions 1208 may be transmitted or received using a transmission medium via the coupling 1228 (e.g., a peer-to-peer coupling) to the devices 1224.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
parsing a Structured Query Language (SQL) statement to generate an Abstract Syntax Tree (AST);
constructing a bi-tree model based on the AST, the bi-tree model comprising a context tree and a select-pattern (SP) tree; and
extracting column-level lineages based on the bi-tree model.

2. The computer-implemented method of claim 1, further comprising:
forming the context tree for a query in the SQL statement, wherein the context tree comprises a plurality of query nodes; and
linking each of the plurality of query nodes into the context tree, wherein the context tree identifies top target columns and bottom physical columns.

3. The computer-implemented method of claim 1, further comprising:
forming a plurality of SP tree nodes for each selected column identified in the AST;
connecting the plurality of SP tree nodes according to a context and dependencies identified in the AST, for each selected column identified in the AST; and
forming one or more SP trees based on connecting the plurality of SP tree nodes for each selected column.

4. The computer-implemented method of claim 1, wherein constructing the bi-tree model comprises:
building the context tree based on the AST;
forming SP tree nodes; and
resolving named columns from the SQL statement with the SP tree nodes.

5. The computer-implemented method of claim 4, further comprising:
resolving unnamed columns from the SQL statement with the SP tree nodes by uplifting dependent nodes and splitting all selected column tree nodes into individual named column nodes.

6. The computer-implemented method of claim 5, further comprising:
connecting all SP tree nodes according to the context tree from top target columns and bottom physical columns.

7. The computer-implemented method of claim 6, further comprising:
extracting the column-level lineages from the top target columns to the bottom physical columns.

8. The computer-implemented method of claim 1, further comprising:
constructing the context tree from the AST, wherein the context tree comprises a plurality of context tree nodes, each context tree node corresponding to a SELECT query or subquery within the SQL statement, and wherein the plurality of context tree nodes are linked to reflect dependencies and context between the plurality of context tree nodes;
forming a plurality of SP tree nodes from the AST, each SP tree node corresponding to a selected column within the SQL statement, including columns represented by a wildcard character;
connecting the SP tree nodes in accordance with the context tree to form one or more SP trees, wherein each SP tree corresponds to a top target column selected in the SQL statement;
extracting column-level lineage information by linking top target columns to bottom physical table columns through the one or more SP trees, wherein the linking defines relationships and dependencies between upstream source table columns and downstream target table columns; and
causing a display of the column-level lineage information.

9. The computer-implemented method of claim 8, further comprising:
resolving named columns by traversing the AST and the context tree; and
identifying explicit column names and their corresponding context within the SQL statement.

10. The computer-implemented method of claim 8, further comprising:
resolving unnamed columns represented by a wildcard character by uplifting dependent nodes and splitting the wildcard character nodes into individual named column nodes.

11. A computing apparatus comprising:
a processor; and
a memory storing instructions that, when executed by the processor, configure the apparatus to:
parse a Structured Query Language (SQL) statement to generate an Abstract Syntax Tree (AST);
construct a bi-tree model based on the AST, the bi-tree model comprising a context tree and a select-pattern (SP) tree; and
extract column-level lineages based on the bi-tree model.

12. The computing apparatus of claim 11, wherein the instructions further configure the apparatus to:
form the context tree for a query in the SQL statement, wherein the context tree comprises a plurality of query nodes; and
link each of the plurality of query nodes into the context tree, wherein the context tree identifies top target columns and bottom physical columns.

13. The computing apparatus of claim 11, wherein the instructions further configure the apparatus to:
form a plurality of SP tree nodes for each selected column identified in the AST;
connect the plurality of SP tree nodes according to a context and dependencies identified in the AST, for each selected column identified in the AST; and
form one or more SP trees based on connecting the plurality of SP tree nodes for each selected column.

14. The computing apparatus of claim 11, wherein constructing the bi-tree model comprises:
build the context tree based on the AST;
form SP tree nodes; and
resolv named columns from the SQL statement with the SP tree nodes.

15. The computing apparatus of claim 14, wherein the instructions further configure the apparatus to:
resolv unnamed columns from the SQL statement with the SP tree nodes by uplifting dependent nodes and splitting all selected column tree nodes into individual named column nodes.

16. The computing apparatus of claim 15, wherein the instructions further configure the apparatus to:
connect all SP tree nodes according to the context tree from top target columns and bottom physical columns.

17. The computing apparatus of claim 16, wherein the instructions further configure the apparatus to:
extract the column-level lineages from the top target columns to the bottom physical columns.

18. The computing apparatus of claim 11, wherein the instructions further configure the apparatus to:
construct the context tree from the AST, wherein the context tree comprises a plurality of context tree nodes, each context tree node corresponding to a SELECT query or subquery within the SQL statement, and wherein the plurality of context tree nodes are linked to reflect dependencies and context between the plurality of context tree nodes;
form a plurality of SP tree nodes from the AST, each SP tree node corresponding to a selected column within the SQL statement, including columns represented by a wildcard character;
connect the SP tree nodes in accordance with the context tree to form one or more SP trees, wherein each SP tree corresponds to a top target column selected in the SQL statement;
extract column-level lineage information by linking top target columns to bottom physical table columns through the one or more SP trees, wherein the linking defines relationships and dependencies between upstream source table columns and downstream target table columns; and
cause a display of the column-level lineage information.

19. The computing apparatus of claim 18, wherein the instructions further configure the apparatus to:
resolve named columns by traversing the AST and the context tree; and
identify explicit column names and their corresponding context within the SQL statement; and
resolve unnamed columns represented by a wildcard character by uplifting dependent nodes and splitting the wildcard character nodes into individual named column nodes.

20. A non-transitory computer-readable storage medium, the computer-readable storage medium including instructions that when executed by a computer, cause the computer to:
parse a Structured Query Language (SQL) statement to generate an Abstract Syntax Tree (AST);
construct a bi-tree model based on the AST, the bi-tree model comprising a context tree and a select-pattern (SP) tree; and
extract column-level lineages based on the bi-tree model.
